(19) United States
(12) Patent Application Publication
(10) Pub. No.: US 2021/0296686 A1
(43) Pub. Date: Sep. 23, 2021

(54) LAMINATED SOLID-STATE BATTERY

(71) Applicant: HONDA MOTOR CO., LTD., Tokyo (JP)

(72) Inventors: Shinji Fujimoto, Saitama (JP); Toru Sukigara, Saitama (JP); Shigemitsu Akutsu, Saitama (JP)

(21) Appl. No.: 17/199,419

(22) Filed: Mar. 11, 2021

(30) Foreign Application Priority Data
Mar. 19, 2020 (JP) 2020-049807

(51) Int. Cl. H01M 10/0562; H01M 10/0525; H01M 10/647; H01M 10/0585; H01M 50/531; H01M 4/13

(52) U.S. Cl. CPC H01M 10/0562; H01M 10/0525; H01M 10/647; H01M 2004/027; H01M 50/531; H01M 4/13; H01M 10/0585

(57) ABSTRACT

To provide a laminated solid-state battery capable of allowing a high voltage to be obtained and the installation space to be reduced. A laminated solid-state battery (100) including a plurality of unit solid-state batteries (10, 10a). Each unit solid-state battery of the plurality of unit solid-state batteries (10, 10a) includes a positive electrode (101, 101a), a negative electrode (102, 102a), and a solid electrolyte (103). The plurality of unit solid-state batteries (10, 10a) are electrically connected to each other in series and housed in a single laminate cell (104).

Preferably, the plurality of unit solid-state batteries (10, 10a) are electrically connected to each other in series inside the laminate cell (104).

This application is based on and claims the benefit of priority from Japanese Patent Application No. 2020-049807, filed on 19 Mar. 2020, the content of which is incorporated herein by reference.

### BACKGROUND OF THE INVENTION

### Field of the Invention

The present invention relates to a laminated solid-state battery.

### Related Art

In recent years, for the rapid expansion of the demand for high capacity and high output secondary batteries, electrolyte batteries such as lithium ion secondary batteries have been provided.

The lithium ion secondary batteries are used, for example, as power sources for mobile phones and electric vehicles.

The lithium ion secondary battery has a structure in which a separator is present between a positive electrode and a negative electrode, and the battery is filled with a liquid electrolyte.

To obtain a high voltage from the secondary battery, it is necessary to connect a plurality of single batteries to each other in series.

However, since the lithium ion secondary battery include liquid electrolytes, it is necessary to prevent the electrolytic solutions from coining into contact with each other and causing a short, circuit. Therefore, it is necessary to house the single batteries in different cells, or to secure insulation between the single batteries (for example, see Patent Document 1).

Patent Document 1: Japanese unexamined Patent Application, Publication No. 2018-156902

### SUMMARY OF THE INVENTION

The serialization of the battery including the liquid electrolytes, such as the lithium ion secondary battery requires an insulation member and the like, which increases the number of parts, the manufacturing cost, and the size of the cell.

In contrast, a solid-state battery including solid electrolytes is unlikely to suffer from a short circuit due to contact between the electrolytes, and allows a plurality of batteries to be housed in a single cell and serialized.

However, the structure regarding the serialization of a plurality of solid-state batteries has not been studied.

The present invention has been made in view of the above, and an object of the invention is to provide a laminated solid-state battery capable of allowing a high voltage to be obtained and the installation space to be reduced.

A first aspect of the present invention relates to a laminated solid-state battery including a plurality of unit solid-state batteries. Each unit solid-state battery of the plurality of unit solid-state batteries includes a positive electrode, a negative electrode, and a solid electrolyte. The plurality of unit solid-state batteries are electrically connected to each other in series and housed in a single laminate cell.

According to the first aspect of the invention, it is possible to provide a laminated solid-state battery capable of allowing a high voltage to be obtained and the installation space to be reduced.

In a second aspect of the invention according to the first aspect, the plurality of unit solid-state batteries are electrically connected to each other in series inside the laminate cell.

According to the second aspect of the invention, since the connecting place of the plurality of unit: solid-state batteries is provided inside, the laminate cell, the installation space of the laminated solid-state battery can be further reduced.

In a third aspect of the invention according to the first aspect or the second aspect, the laminated solid-state battery includes a positive electrode tab electrically connected to any of the positive electrodes, and a negative electrode tab electrically connected to any of the negative electrodes. The positive electrode tab and the negative electrode tab extend outward from a same side face of the laminate cell.

According to the third aspect of the invention, since the positive electrode tab and the negative electrode tab extend from the same side face of the laminated cell, the installation space of the laminated solid-state battery can be further reduced.

In a fourth aspect of the invention according to any one of the first aspect to the third aspect, the laminated solid-state battery includes at least one pair of the positive electrode and the negative electrode being arranged at positions where they overlap with each other at least partially in planar view, and the pair of the positive electrode and the negative electrode are electrically connected to each other.

According to the fourth aspect of the invention, since the positive electrode and the negative electrode can be easily connected to each other, the manufacturing cost of the laminated solid-state battery can be reduced.

### BRIEF DESCRIPTION OF THE DRAWINGS

FIG. 1A is a schematic view (front view) of a laminated solid-state battery according to a first embodiment;

FIG. 1B is a plan view of FIG. 1A;

FIG. 1C is a side view of FIG. 1A;

FIG. 1D is a side view of FIG. 1A;

FIG. 2A is a schematic view (front view) of a laminated solid-state battery according to a second embodiment;

FIG. 2B is a plan view of FIG. 2A;

FIG. 2C is a side view of FIG. 2A;

FIG. 2D is a side view of FIG. 2A;

FIG. 3A is a schematic view (front view) of a laminated solid-state battery according to a third embodiment;

FIG. 3B is a plan view of FIG. 3A;

FIG. 3C is a side view of FIG. 3A;

FIG. 3D is a side view of FIG. 3A;

FIG. 4A is a schematic view (front view) of a laminated solid-state battery according to a fourth embodiment;

FIG. 4B is a plan view of FIG. 4A;

FIG. 4C is a side view of FIG. 4A;

FIG. 5A is a schematic view (front view) of a laminated solid-state battery according to a fifth embodiment;

FIG. 5B is a plan view of FIG. 5A;

FIG. 5C is a side view of FIG. 5A;

FIG. 5D is a side view of FIG. 5A;

FIG. 6A is a schematic view (front view) of a laminated solid-state battery according to a sixth embodiment;

FIG. 6B is a plan view of FIG. 6A;

FIG. 6C is a side view of FIG. 6A;

FIG. 6D is a rear view of FIG. 6A;

FIG. 7A is a schematic view (front view) of a laminated solid-state battery according to a seventh embodiment;

FIG. 78 is a plan view of FIG. 7A;

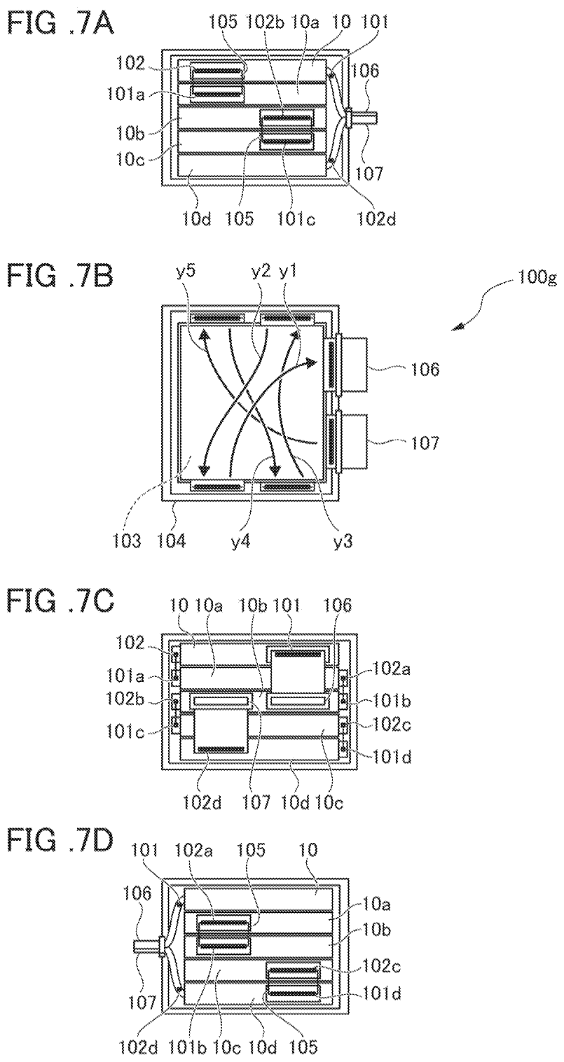

FIG. 7c is a side view of FIG. 7A; and

FIG. 71) is a rear view of FIG. 7A.

### DETAILED DESCRIPTION OF THE INVENTION

### First Embodiment

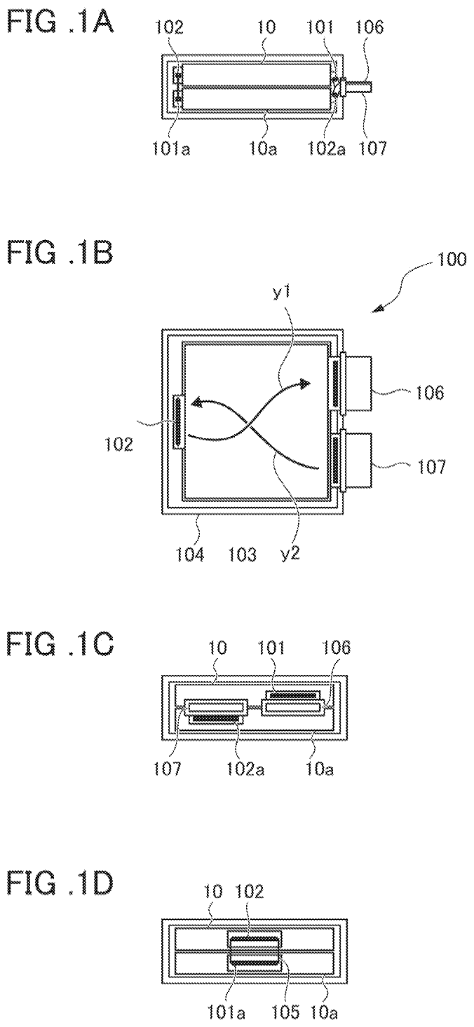

FIG. 1 is a schematic diagram showing a laminated solid-state battery according to a first embodiment of the present invention. As shown in FIG. 1, a laminated solid-state battery 100 according to the present embodiment includes two unit solid-state batteries 10 and 10a, a laminate cell 104, a positive electrode tab 106, and a negative electrode tab 107.

The two unit solid-state batteries 10 and 10a include positive electrodes 101 and 101a, negative electrodes 102 and 102a, and solid electrolytes 103 presenting between the positive electrodes and the negative electrodes, respectively.

The two unit solid-state batteries 10 and 10a are electrically connected in series by a welded portion 105, and are housed in the laminate cell 104.

A separator may be arranged between the two unit solid-state batteries 10 and 10a as necessary.

The positive electrodes 101 and 101a and the negative electrodes 102 and 102a are not particularly limited, and an ordinary structure used as a positive electrode or a negative electrode of a solid-state battery can be used.

The positive electrode and the negative electrode each contain a current collector, an active material, a solid electrolyte, and the like, and may optionally contain an electroconductive auxiliary agent, a binder, and the like.

The positive electrode and the negative electrode are formed in layers, for example.

In this case, in the positive electrode and the negative electrode, current collectors for collecting current of the positive electrode layer and the negative electrode layer extend and have portions that are connected to another unit solid-state battery or the electrode tab described later.

The material of the current collector is not particularly limited, and examples of the material of the positive electrode current collector include aluminum, an aluminum alloy, stainless steel, nickel, iron, and titanium.

Examples of the material of the negative electrode current collector include nickel, copper, and stainless steel.

Examples of the shape of the current collector include a foil shape and a plate shape.

The positive electrode active material contained in the positive electrode is not particularly limited, and a known material capable of releasing and occluding charge transfer media can be appropriately selected and used.

Examples of the positive electrode active material include lithium cobaltate, lithium nickelate, lithium manganate, heterogeneous element-substituted Li—Mn spinel, and lithium metal phosphate.

Similarly, the negative electrode active material contained in the negative electrode is not particularly limited, and a known material capable of releasing and occluding charge transfer media can be appropriately selected and used.

Examples of the negative electrode active material include lithium transition metal oxides such as lithium titanate, transition metal oxides such as TiO₂, Nb₂O₃, and WO₃, metal sulfides, metal nitrides, carbon materials such as graphite, soft carbon, and hard carbon, metallic lithium, metallic indium, and lithium alloys.

As shown in FIGS. 1A and 1B, the positive electrode 101 and the negative electrode 102 of the unit solid-state battery 10 according to the present, embodiment are arranged on opposite sides of the laminate cell 104 in planar view.

Similarly, the positive electrode 101a and the negative electrode 102a of the unit, solid-state battery 10a are arranged on opposite sides of the laminate ceil 104 in planar view.

The negative electrode 102 and the positive electrode 101a are arranged, in planar view, on the same side face of the laminate cell 104 and at positions where they overlap with each other at least partially.

The positive electrode 101 and the negative electrode 102a are arranged, in planar view, on the same side face of the laminate cell 104 and at positions where they do not overlap with each other.

Arrows y1 and y2 in FIG. 1B schematically illustrate the directions of current flow in the unit solid-state batteries 10 and 10a, respectively.

As indicated by the arrow y1, current flows from the negative electrode 102 toward the positive electrode 101 in the unit solid-state battery 10.

As indicated by the arrow y2, current flows from the negative electrode 102a toward the positive electrode 101a in the unit solid-state battery 10a.

Due to the arrangement of the positive electrodes and the negative electrodes, charge transfer media are uniformly transferred in the solid electrolytes 103.

The solid electrolyte 103 is arranged between the positive electrode and the negative electrode.

The solid electrolyte 103 conducts charge transfer media between the positive electrode active material contained in the positive electrode and the negative electrode active material contained in the negative electrode.

The solid electrolyte 103 is not particularly limited, and for example, a sulfide solid electrolyte material, an oxide solid electrolyte material, a nitride solid electrolyte material, a halide solid electrolyte material, or the like can be used.

When the positive electrode and the negative electrode are formed in layers, the solid electrolyte 103 can be similarly formed in layers.

The laminate cell 104 houses the unit solid-state batteries 10 and 10a inside.

The laminate cell 104 has a multilayer structure in which a heat-fusible resin layer such as polyolefin is laminated on the outer side of a metal layer made of aluminum, stainless steel (SUS), or the like, for example.

In addition to the above, the laminate cell 104 may include a layer made of polyamide such as nylon, polyester such as polyethylene terephthalate, or the like, and an adhesive layer made of an optional laminate adhesive, or the like.

For the laminate cell 104, for example, a single rectangular laminated sheet is folded to sandwich the unit solid-state batteries 10 and 10a, and then sealed outside the unit solid-state batteries 10 and 10a by a heat-sealing method or other method to house the unit solid-state batteries 10 and 10a inside.

The welded portion 105 electrically connects the unit solid-state batteries 10 and 10a to each other in series.

In the present embodiment, the welded portion 105 electrically connects the negative electrode 102 of the unit solid-state battery 10 to the positive electrode 101a of the unit solid-state battery 10a. The welded portion 105 is formed, for example, by welding the negative electrode 102 and the positive electrode 101a by vibration welding, ultrasonic welding, or the like.

As shown in FIGS. 1A and 1D, the negative electrode 102 and the positive electrode 101a are arranged at positions where they overlap with each other at least partially in planar view.

Thus, the negative electrode 102 and the positive electrode 101a can be directly welded without requiring a separate member.

The welding between the negative electrode 102 and the positive electrode 101a may be performed through a separate electroconductive member such as a cladding material.

The welded portion 105 is formed inside the laminate cell 104. This allows the laminated solid-state battery 100 to be compactly configured, reducing the installation space.

In addition, since the welded portion 105 can be formed without requiring a separate member, the manufacturing cost of the laminated solid-state battery 100 can be reduced.

The positive electrode tab 106 and the negative electrode tab 107 are electrically connected to the positive electrode current collector or the negative electrode current collector in the positive electrode and the negative electrode.

In the present embodiment, the positive electrode tab 106 is electrically connected to the positive electrode current collector of the positive electrode 101, and the negative electrode tab 107 is electrically connected to the negative electrode current collector of the negative electrode 102a.

As shown in FIGS. 1A to 1C, the positive electrode tab 106 and the negative electrode tab 107 extend from the same side face of the laminate cell 104 toward the outside of the laminate cell 104. In FIG. 1A, the positive electrode tab 106 and the negative electrode tab 107 are arranged at the central part in the thickness direction of the laminate cell 104, and extend horizontally from the positive electrode 101 and the negative electrode 102a, respectively. The positive electrode tab 106 and the negative electrode tab 107 can be optionally modified depending on the application.

For example, the positive electrode tab 106 and the negative electrode tab 107 can be bent and used.

Other embodiments of the present invention will be described below.

Description of the same structure as that of the first embodiment may be omitted.

### Second Embodiment

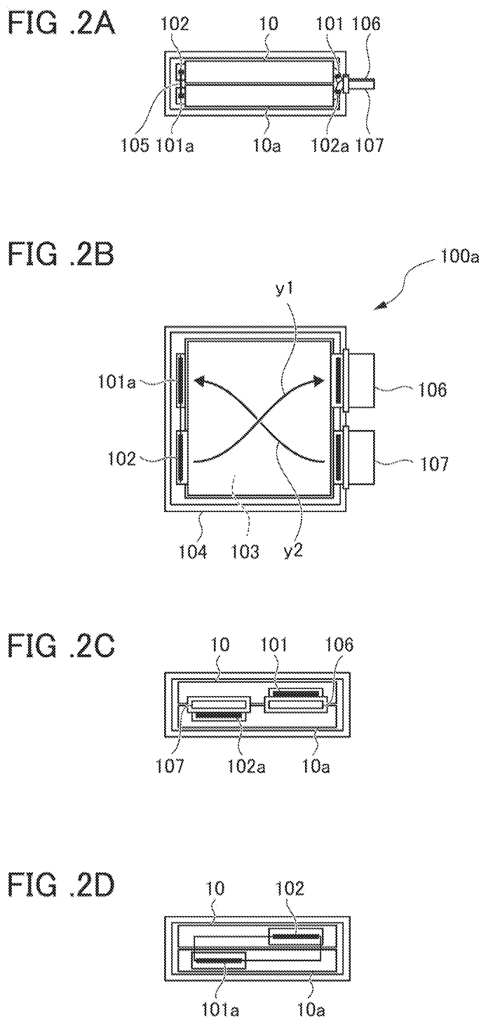

FIG. 2 is a schematic diagram showing a laminated solid-state battery 100a according to a second embodiment of the present invention.

The laminated solid-state battery 100a includes the two unit solid-state batteries 10 and 10a similarly to the first embodiment.

In this embodiment, the negative electrode 102 of the unit solid-state battery 10 and the positive electrode 101a of the unit solid-state battery 10a are electrically connected to each other by the welded portion 105.

As shown in FIGS. 2B and 2D, the negative electrode 102 and the positive electrode 101a are arranged at positions where they do not overlap with each other in planar view and at different positions in the vertical direction.

The negative electrode 102 and the positive electrode 101a are welded and connected by the welded portion 105 using an electroconductive member.

As shown in FIGS. 2A and 2B, with respect to the positive electrode 101 and the negative electrode 102 of the unit solid-state battery 10, and the positive electrode 101a and the negative electrode 102a of the unit solid-state battery 10a, the positive electrode and the negative electrode of each unit solid-state battery are arranged on opposite side faces of the laminated cell 104 in planar view. The positive electrode 101 and the negative electrode 102a are arranged, in planar view, on the same side face of the laminate cell 104 and at positions where they do not overlap with each other. Similarly, the negative electrode 102 and the positive electrode Ida are arranged, in planar view, on the same side face of the laminate cell 104 and at positions where they do not overlap with each other.

As shown by the arrow y1 in FIG. 2B, current flows from the negative electrode 102 to the positive electrode 101 of the unit solid-state battery 10.

Similarly, as indicated by the arrow y2, current flows from the negative electrode 102a to the positive electrode 101a of the unit solid-state battery 10a.

Due to the arrangement of the positive electrodes and the negative electrodes, charge transfer media are uniformly transferred in the solid electrolytes 103.

### Third Embodiment

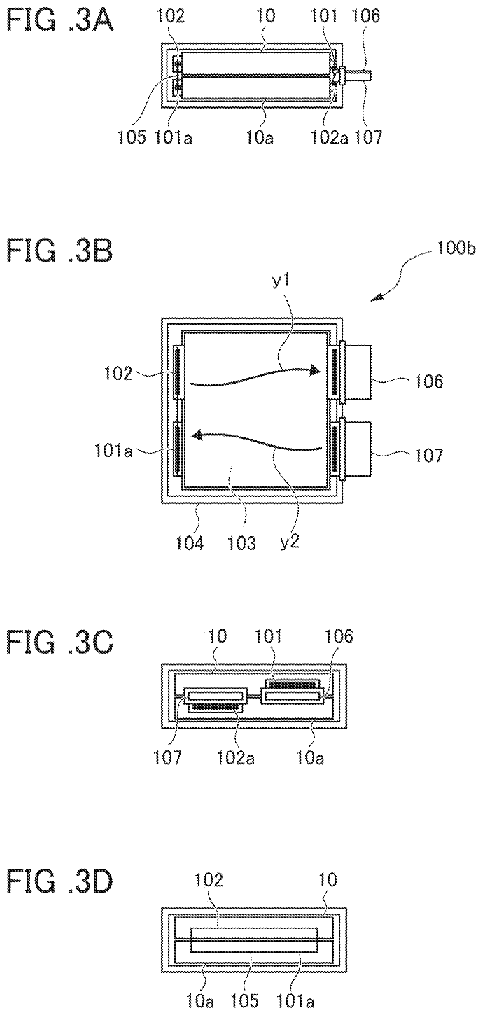

FIG. 3 is a schematic diagram showing a laminated solid-state battery 100b according to a third embodiment of the present invention. The laminated solid-state battery 100b includes the two unit solid-state batteries 10 and 10a similarly to the first and second embodiments.

In this embodiment, the negative electrode 102 of the unit solid-state battery 10 and the positive electrode 101a of the unit solid-state battery 10a are electrically connected to each other by the welded portion 105.

As shown in FIGS. 3B and 3D, the negative electrode 102 and the positive electrode 101a are arranged at positions where they do not overlap with each other in planar view and at different positions in the vertical direction.

The negative electrode 102 and the positive electrode 101a are welded and connected by the welded portion 105 using an electroconductive member.

Similarly to the first and second embodiments, the welded portion 105 is formed inside the laminate cell 104.

With respect to the positive electrode 101 and the negative electrode 102 of the unit solid-state battery 10, and the positive electrode 101a and the negative electrode 102a of the unit solid-state battery 10a, the positive electrode and the negative electrode of each unit solid-state battery are arranged at positions where they do not overlap with each other in planar view.

As shown in FIGS. 3A and B, with respect to the positive electrode 101 and the negative electrode 102 of the unit solid-state battery 10, and the positive electrode 101a and the negative electrode 102a of the unit solid-state battery 10a, the positive electrode and the negative electrode of each unit solid-state battery are provided on opposite positions in planar view.

Accordingly, as indicated by the arrow y1 in FIG. 3B, current flows from the negative electrode 102 to the positive electrode 101 of the unit solid-state battery 10.

Similarly, as indicated by the arrow y2, current flows from the negative electrode 102a to the positive electrode 101a of the unit solid-state battery 10a.

### Fourth Embodiment

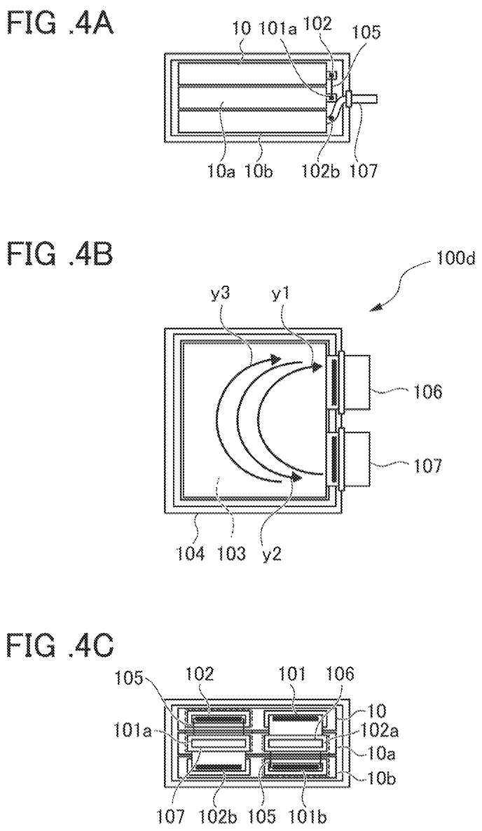

FIG. 4 is a schematic diagram showing a laminated solid-state battery 100d according to a fourth embodiment of the present invention.

The laminated solid-state battery 100d includes three unit solid-state batteries 10, 10a, and 10b.

The negative electrode 102 of the unit solid-state battery 10 and the positive electrode 101a of the unit solid-state battery 10a are electrically connected to each other inside the laminate cell 104 by the welded portion 105.

Similarly, the negative electrode 102a of the unit solid-state battery 10a and the positive electrode 101b of the unit solid-state battery 10b are electrically connected to each other inside the laminate cell 104 by the welded portion 105.

As shown in FIGS. 4A to 4C, the positive electrodes 101, 101a, and 101b, and the negative electrodes 102, 102a, and 102b according to the present embodiment are arranged on the same side face of the laminate cell 104 in planar view.

The positive electrode 101, the negative electrode 102a, and the positive electrode 101b are arranged at positions where they overlap with one another at least partially in planar view, and the negative electrode 102, the positive electrode 101a, and the negative electrode 102b are arranged at positions where they overlap with one another at least partially in planar view.

Accordingly, as indicated by the arrow y1 in BIG. 4B, current flows from the negative electrode 102 to the positive electrode 101 of the unit solid-state battery 10.

Similarly, as indicated by the arrow y2, current flows from the negative electrode 102a to the positive electrode 101a of the unit solid-state battery 10a.

Similarly, as indicated by the arrow y3, current flows from the negative electrode 102b to the positive electrode 101b of the unit solid-state battery 10b.

### Fifth Embodiment

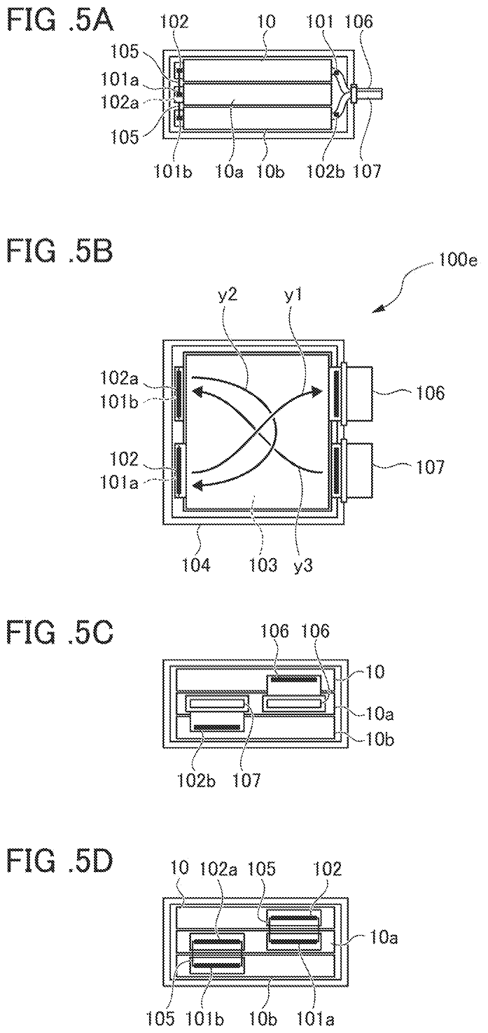

FIG. 5 is a schematic diagram showing a laminated solid-state battery 100e according to a fifth embodiment of the present invention. Similarly to the fourth embodiment, the laminated solid-state battery 100e includes the three unit solid-state batteries 10, 10a, and 10b.

As shown in FIGS. 5B and 5D, the negative electrode 102 of the unit solid-state battery 10 and the positive electrode 101a of the unit solid-state battery 10a are arranged so as to overlap with each other at least partially in planar view, and are welded and electrically connected to each other inside the laminate cell 104 by the welded portion 105.

Similarly, the negative electrode 102a of the unit solid-state battery 10a and the positive electrode 101b of the unit solid-state battery 10b are arranged so as to overlap with each other at least partially in planar view, and are welded and electrically connected to each other inside the laminate cell 104 by the welded portion 105.

The positive electrode tab 106 and the negative electrode tab 107 are arranged at positions where they do not overlap with each other in planar view.

Accordingly, as indicated by the arrow y1 in FIG. 5B, current flows from the negative electrode 102 to the positive electrode 101 of the unit solid-state battery 10.

Similarly, as indicated by the arrow y2, current flows from the negative electrode 102a to the positive electrode 101a of the unit solid-state battery 10a.

Similarly, as indicated by the arrow y3, current flows from the negative electrode 102b to the positive electrode 101b of the unit solid-state battery 10b.

### Sixth Embodiment

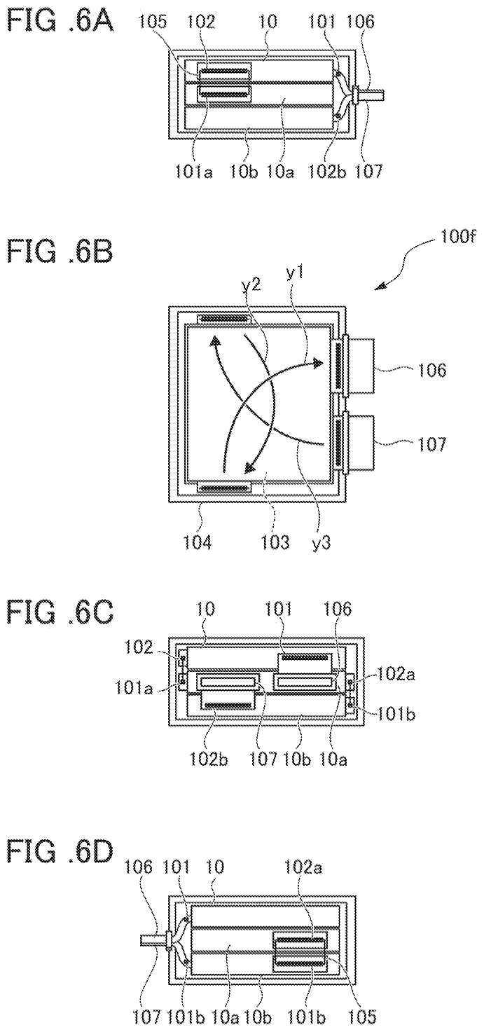

FIG. 6 is a schematic diagram showing a laminated solid-state battery 100f according to a sixth embodiment of the present invention. Similarly to the fourth and fifth embodiments, the laminated solid-state battery 100f includes the three unit solid-state batteries 10, 10a, and 10b.

As shown in FIGS. 6A and 6B, the negative electrode 102 of the unit solid-state battery 10 and the positive electrode 101a of the unit solid-state battery 10a are arranged so as to overlap with each other at least partially in planar view, and are welded and electrically connected to each other inside the laminate cell 104 by the welded portion 105.

Similarly, as shown in FIGS. 6B and 60, the negative electrode 102a of the unit solid-state battery 10a and the positive electrode 101b of the unit solid-state battery 10b are arranged so as to overlap with each other at least partially in planar view, and are welded and electrically connected to each other inside the laminate cell 104 by the welded portion 105.

As shown in FIGS. 6′A and 68, the positive electrode 101 and the negative electrode 102 of the unit solid-state battery 10 are arranged on adjacent side faces of the laminate cell 104 in planar view. Similarly, the positive electrode 101a and the negative electrode 102a of the unit solid-state battery 10a are arranged on opposite side faces of the laminate cell 104 in planar view.

Similarly, the positive electrode 101b and the negative electrode 102b of the unit, solid-state battery 10b are arranged on adjacent side faces of the laminate cell 104 in planar view.

Accordingly, as indicated by the arrow y1 in FIG. 6B, current flows from the negative electrode 102 to the positive electrode 101 of the unit solid-state battery 10.

Similarly, as indicated by the arrow y2, current flows from the positive electrode 101a to the negative electrode 102a of the unit solid-state battery 10a. Similarly, as indicated by the arrow y3, current flows from the negative electrode 102b to the positive electrode 101b of the unit solid-state battery 10b.

### Seventh Embodiment

FIG. 7 is a schematic diagram showing a laminated solid-state battery 100g according to a seventh embodiment of the present invention.

The laminated solid-state battery 100g includes five unit solid-state batteries 10, 10a, 10b, 10c, and 10d.

As shown in FIGS. 7A and 7B, the negative, electrode 102 of the unit solid-state battery 10 and the positive electrode 101a of the unit solid-state battery 10a are arranged so as to overlap with each other at least partially in planar view, and are welded and electrically connected to each other inside the laminate cell 104 by the welded portion 105.

Similarly, as shown in FIGS. 7A, 7B, and 7C, with respect to the negative electrode 102a of the unit, solid-state battery 10a and the positive electrode 101b of the unit solid-state battery 10b, the negative electrode 102b of the unit, solid-state battery 10b and the positive electrode 101c of the unit solid-state battery 10c, and the negative electrode 102c of the unit, solid-state battery 10c and the positive electrode 101d of the unit solid-state battery 10d, the positive electrode and the negative electrode of each of the above pairs are arranged so as to overlap with each other at least partially in planar view, and are welded and electrically connected to each other inside the laminate cell 104 by the welded portion 105.

As shown in FIGS. 7A and 7B, the positive electrode 101 and the negative electrode 102 of the unit solid-state battery 10 are arranged on adjacent side faces of the laminated cell 104 in planar view. Similarly, the positive electrode 101a and the negative electrode 102a of the unit solid-state battery 10a are arranged on opposite side faces of the laminate cell 104 in planar view.

Similarly, as shown in FIGS. 7A, 73, and 70, with respect to the positive electrode 101b and the negative electrode 102b of the unit solid-state battery 10b, and the positive electrode 101c and the negative electrode 102c of the unit solid-state battery 10c, the positive electrode and the negative electrode of each unit solid-state battery are arranged on opposite side faces of the laminate cell 104 in planar view.

The positive electrode 101d and the negative electrode 102d of the unit solid-state battery 10d are arranged on adjacent side faces of the laminate cell 104 in planar view.

As indicated by the arrow y1 in FIG. 7B, current flows from the negative electrode 102 to the positive electrode 101 of the unit solid-state battery 10.

Similarly, as indicated by the arrow y2, current flows from the negative electrode 102a to the positive electrode 101a of the unit solid-state battery 10a.

Similarly, as indicated by the arrow y3, current flows from the negative electrode 102b to the positive electrode 101b of the unit solid-state battery 10b, Similarly, as indicated by the arrow y4, current flows from the negative electrode 102c to the positive electrode 101c of the unit solid-state battery 10c.

Similarly, as indicated by the arrow y5, current flows from the negative electrode 102d to the positive electrode 101d of the unit solid-state battery 10d.

While preferred embodiments of the present invention have been described above, the present invention is not limited to the above-described embodiments, and those appropriately modified are also included in the scope of the present invention.

### EXPLANATION OF REFERENCE NUMERALS

100, 100a, 100b, 100c, 100d, 100e, 100f, 100g laminated solid-state battery
10, 10a, 10b, 10c, 10d unit solid-state battery
101, 101a, 101b, 101c, 101d positive electrode
102, 102a, 102b, 102c, 102d negative electrode
103 solid electrolyte
104 laminate cell
106 positive electrode tab
107 negative electrode, tab

What is claimed is:

1. A laminated solid-state battery comprising:
a plurality of unit solid-state batteries,
each unit solid-state battery of the plurality of unit solid-state batteries comprising a positive electrode, a negative electrode, and a solid electrolyte, and
the plurality of unit solid-state batteries being electrically connected to each other in series and housed in a single laminate cell.

2. The laminated solid-state battery according to claim 1, wherein the plurality of unit solid-state batteries are electrically connected to each other in series inside the laminate cell.

3. The laminated solid-state battery according to claim 1,
wherein the laminated solid-state battery comprises a positive electrode tab electrically connected to any of the positive electrodes, and
a negative electrode tab electrically connected to any of the negative electrodes,
the positive electrode tab and the negative electrode tab extending outward from a same side face of the laminate cell.

4. The laminated solid-state battery according to claim 1, wherein the laminated solid-state battery comprises at least one pair of the positive electrode and the negative electrode being arranged at positions Where they overlap with each other at least, partially in planar view, the pair of the positive electrode and the negative electrode being electrically connected to each other.
